(19) United States
(12) Patent Application Publication
(10) Pub. No.: US 2024/0131852 A1
(43) Pub. Date: Apr. 25, 2024

(54) CHEMICAL STORAGE APPARATUS AND CHEMICAL DISPENSING APPARATUS INCLUDING THE SAME

(71) Applicant: SEMES CO., LTD., Cheonan-si (KR)

(72) Inventors: Donghwa Lee, Cheonan-si (KR); Daigeon Yoon, Cheonan-si (KR); Soohong Lee, Cheonan-si (KR); Bongman Choi, Cheonan-si (KR); Daesung Kim, Cheonan-si (KR)

(73) Assignee: SEMES CO., LTD., Cheonan-si (KR)

(21) Appl. No.: 18/382,388

(22) Filed: Oct. 19, 2023

(30) Foreign Application Priority Data
Oct. 20, 2022 (KR) 10-2022-0136849

(51) Int. Cl. B41J 2/175

(52) U.S. Cl. CPC B41J 2/17566; B41J 2002/17579

(57) ABSTRACT

Provided is a chemical storage apparatus including a reservoir including a chemical tank configured to store a chemical, a first fixing member disposed on an upper surface of the chemical tank, and a second fixing member disposed on a lower surface of the chemical tank, a sensor configured to measure a specific parameter of the chemical stored in the reservoir, a receptacle having a space in which the sensor is accommodated, and coupling members for attaching or detaching the receptacle to or from the first fixing member and the second fixing member, respectively.

### CROSS-REFERENCE TO RELATED APPLICATION

This application is based on and claims priority under 35 U.S.C. § 119 to Korean Patent Application No. 10-2022-0136849, filed on Oct. 21, 2022, in the Korean Intellectual Property Office, the disclosure of which is incorporated by reference herein in its entirety.

### BACKGROUND

### 1. Field

The disclosure relates to a chemical storage apparatus and a chemical dispensing apparatus including the same, and more particularly, to a chemical storage apparatus for temporarily storing a chemical and supplying the chemical to a nozzle and a chemical dispensing apparatus including the chemical storage apparatus.

### 2. Description of the Related Art

A liquid crystal display device for displaying images includes two substrates on which various thin films are deposited and a liquid crystal layer positioned between the two substrates. Generally, the thin films on each substrate are formed through a deposition process and a photolithography process for pattern precision because the thin films have patterns of various shapes. Such a photolithography process in which an expensive mask is used to form one thin film increases the manufacturing cost and the manufacturing process time.

Recently, an inkjet printing method to form a thin film has been used as an alternative to such conventional processes. Since in the inkjet printing method a thin film is formed by applying a chemical to a specific location on a substrate, a separate etching process is not required. The inkjet printing method may be used to form a color filter or an alignment film of a liquid crystal display device.

### SUMMARY

Provided is a chemical storage apparatus that allows easy replacement of a sensor attached thereto.

Provided is a chemical dispensing apparatus that allows easy replacement of a sensor attached to the chemical storage apparatus.

Additional aspects will be set forth in part in the description which follows and, in part, will be apparent from the description, or may be learned by practice of the presented embodiments of the disclosure.

According to an aspect of the disclosure, a chemical storage apparatus includes a reservoir including a chemical tank configured to store a chemical, a first fixing member positioned on an upper surface of the chemical tank and a second fixing member positioned on a lower surface of the chemical tank, a sensor configured to measure a specific parameter of the chemical stored in the reservoir, a receptacle having a space in which the sensor is accommodated, and coupling members for attaching or detaching the receptacle to or from the first fixing member and the second fixing member, respectively, in a one-touch manner.

In an embodiment, the receptacle may include a first plate and a second plate, wherein the first plate includes a recess in which the sensor is accommodated and contacts a first surface which is a side of the chemical tank, and the second plate covers the sensor accommodated in the recess.

In an embodiment, the first surface may have a curve with a diameter of 40 mm or more or is flat.

In an embodiment, the first plate may have a first body formed with a recess and first heads protruding in a vertical direction from the first body and having holes formed therein, and the coupling members may pass the holes and be coupled to the first fixing member and the second fixing member, respectively.

In an embodiment, the coupling members may include a knob.

In an embodiment, the sum of the thickness of the first body and the thickness of the first surface in a second horizontal direction may be 6 mm or less.

In an embodiment, the sensor may include a liquid level sensor that continuously measures the liquid level of the chemical stored in the reservoir.

In an embodiment, the liquid level sensor may include a capacitance-type liquid level sensor.

In an embodiment, the first fixing member and the second fixing member may each include a valve configured to control a flow rate of the chemical.

In an embodiment, the chemical tank, the first plate, the second plate, the first fixing member, the second fixing member, and the receptacle may include a non-conductive material.

According to another aspect of the disclosure, a chemical dispensing apparatus includes a chuck configured to support a substrate, a head having a nozzle dispensing a chemical toward the substrate, a body to which the head is coupled, a bracket coupled to the body, a reservoir including a chemical tank located in the body and configured to store the chemical, a first fixing member located on an upper surface of the chemical tank, a second fixing member located on a lower surface of the chemical tank, and a supply line for supplying the chemical to the nozzle, a sensor contacting the reservoir and configured to measure a specific parameter of the chemical stored in the reservoir, a receptacle having a space in which the sensor is accommodated, and coupling members for attaching or detaching the receptacle to or from the first fixing member and the second fixing member, respectively, in a one-touch manner.

In an embodiment, the receptacle may include a first plate and a second plate, wherein the first plate has a recess in which the sensor is accommodated, and contacts a first surface which is a side of the chemical tank, and the second plate covers the sensor accommodated in the recess.

In an embodiment, the first surface may have a curve with a diameter of 40 mm or more or is flat.

In an embodiment, the first plate may have a first body formed with a recess and first heads protruding in a vertical direction from the first body and having holes formed therein, and the coupling members may pass the holes and be coupled to the first fixing member and the second fixing member, respectively.

In an embodiment, the sum of the thickness of the first body and the thickness of the first surface in a second horizontal direction may be 6 mm or less.

In an embodiment, the sensor may include a capacitance-type liquid level sensor that continuously measures the liquid level of the chemical stored in the reservoir.

In an embodiment, the chemical tank, the first fixing member, the second fixing member, and the receptacle may include non-conductive material.

According to another aspect of the disclosure, a chemical dispensing apparatus includes a chuck configured to support a substrate, a head having a nozzle for dispensing a chemical toward the substrate, a body to which the head is coupled, a bracket coupled to the body, a reservoir including a chemical tank located in the body and configured to store the chemical, a first fixing member located on an upper surface of the chemical tank, a second fixing member located on a lower surface of the chemical tank, and a supply line for supplying the chemical to the nozzle, a liquid level sensor contacting the reservoir and configured to measure the liquid level of the chemical stored in the reservoir, a receptacle including a first plate having a recess in which the liquid level sensor is accommodated, and a second plate that covers the liquid level sensor accommodated in the recess, and coupling members that attach or detach the receptacle to or from the first fixing member and the second fixing member, respectively, in a one-touch manner, wherein a first surface, which is a side of the chemical tank, has a curve with a diameter of 40 mm or more or is flat, wherein the first plate includes a first body having a recess and first heads protruding in a vertical direction from the first body and having holes formed therein, and wherein the sum of the thickness of the first body and the thickness of the first surface in a second horizontal direction is 6 mm or less.

In an embodiment, each of the first fixing member and the second fixing member may include a valve configured to control a flow rate of the chemical.

In an embodiment, the liquid level sensor may include a capacitance-type liquid level sensor that continuously measures the liquid level of the chemical stored in the reservoir.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic configuration diagram of chemical application equipment;

FIG. 2 is a schematic perspective view of a chemical dispensing apparatus;

FIG. 3 is a schematic plan view of a chemical dispensing apparatus;

FIG. 4 is a schematic perspective view of a chemical storage apparatus of the chemical dispensing apparatus of FIG. 3; and

FIG. 5 is a schematic perspective view of a receptacle and a sensor.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

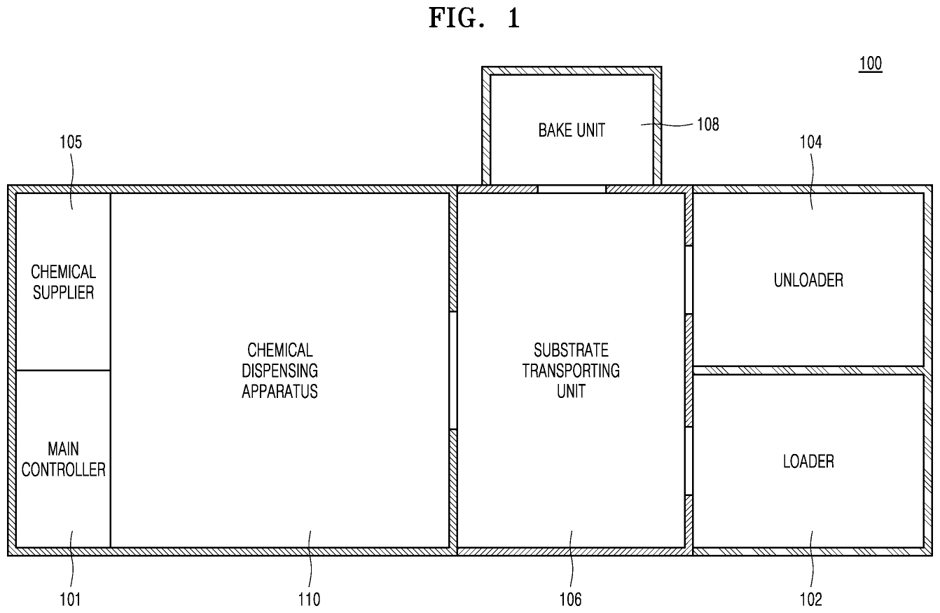

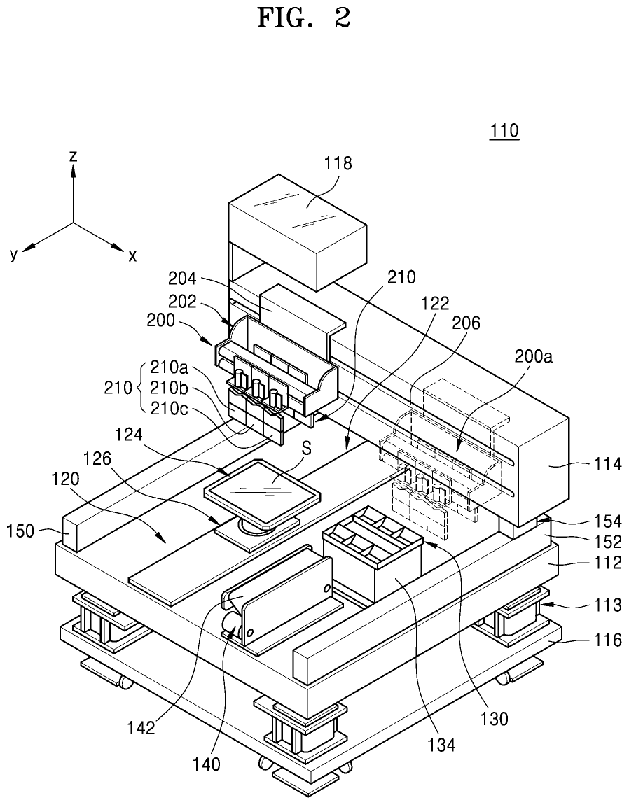

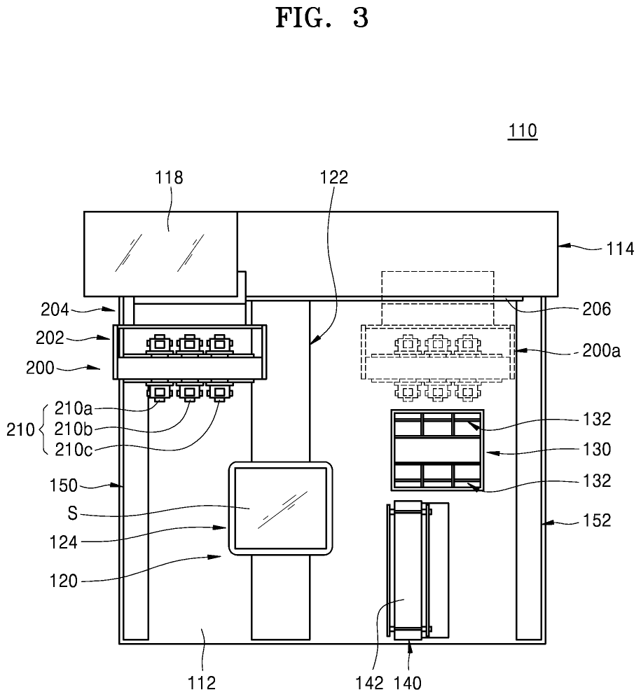

FIG. 1 is a schematic configuration diagram of chemical application equipment. FIG. 2 is a schematic perspective view of a chemical dispensing apparatus. FIG. 3 is a schematic plan view of a chemical dispensing apparatus.

Referring to FIG. 1, the chemical application equipment 100 applies a chemical to an upper surface of a target (not shown) using an inkjet method and includes a chemical dispensing apparatus 110. The target may include a rectangular flat plate, e.g., a glass substrate for manufacturing color filters, alignment films, etc. of chemical liquid display panels, a printed circuit board for forming a metal thin film on a circuit pattern, and a plate to be printed with the chemical by an inkjet method.

The chemical application equipment 100 may include a chemical dispensing apparatus 110 for printing a surface of substrates by an inkjet method, a loader 102 on which substrates are loaded, an index 106 for withdrawing the substrates from the loader 102 and supplying the substrates to the chemical dispensing apparatus 110, and an unloader 104 for loading the substrates on which the chemical has been applied.

The index 106 may be provided with a transfer robot (not shown) that transfers substrates between the loader 102, the chemical dispensing apparatus 110, and the unloader 104. The chemical application equipment 100 may include a chemical supplier 105 for supplying a chemical to the chemical dispensing apparatus 110. The chemical application equipment 100 may also include a main controller 101, as an electric field controller, which controls the overall operations of the chemical application equipment 100.

Referring to FIGS. 2 and 3, the chemical dispensing apparatus 110 which applies a chemical to a surface of a substrate S using an inkjet method may include a base 116 made of steel, a stage 112 disposed over the base 116, a head assembly 200 disposed over the stage 112 and having inkjet heads 210 for applying a chemical to a surface of the substrate S seated on the stage 112, and a gantry 114 for supporting the head assembly 200. The chemical dispensing apparatus 110 may include anti-vibration members 113 to block vibration between the base 116 and the stage 112.

The head assembly 200 may be provided as a multi-head array (MHA) unit. The head assembly 200 may include inkjet heads 210a, 210b, and 210c that dispense chemicals in an inkjet manner. A driver 204 coupled to the bracket 202 on which the inkjet heads 210 are installed may move the head assembly 200 in at least one direction.

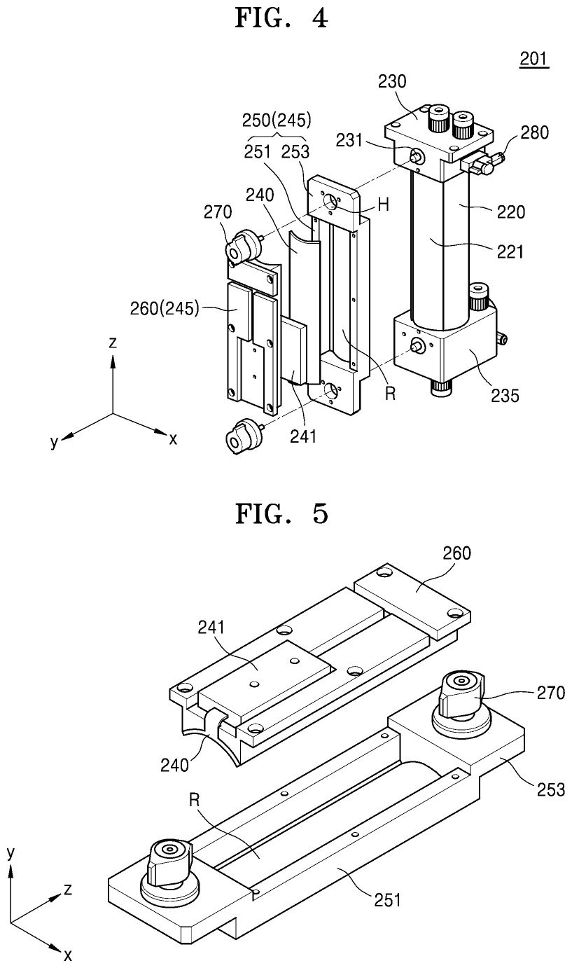

The inkjet heads 210 may be installed in two rows on the front and rear surfaces of the bracket 202. That is, the inkjet heads 210 may be disposed side by side on both front and rear surfaces of the bracket 202 in a Y-axis direction. Each of the inkjet heads 210 may be connected to the chemical supplier (105 in FIG. 1) to receive chemicals. According to embodiments, each of the inkjet heads 210 may be supplied with the same or different chemicals. According to embodiments, the inkjet heads 210 may receive chemicals from the chemical storage apparatus 201 (see FIG. 4) temporarily storing chemicals supplied from the chemical supplier (105 in FIG. 1). That is, the chemical supplier (105 in FIG. 1) may supply chemicals to the chemical storage apparatus 201 (see FIG. 4), and the chemical storage apparatus 201 (see FIG. 4) may temporarily store the chemicals, and then supply the chemicals to the inkjet heads 210.

Each of the inkjet heads 210 for dispensing chemicals to the surface of the substrate S may have a head provided at a lower end thereof. Each of the the heads may have a nozzle surface provided with nozzle for supplying chemicals to the substrate S on a lower surface thereof facing the surface of the substrate S. Each of the nozzles may individually dispense chemicals to the substrate S. The head may be coupled to a body. The body may be coupled to the bracket 202. According to embodiments, the chemical storage apparatus 201 (see FIG. 4) to be described below may be provided in the body.

In the following drawings, an X-axis direction and the Y-axis direction may represent directions parallel to the upper or lower surface of the substrate S, and the X-axis direction may be perpendicular to the Y-axis direction. A Z-axis direction may represent a direction perpendicular to the upper or lower surface of the substrate S. In other words, the Z-axis direction may be a direction perpendicular to the X-Y plane.

In addition, in the following drawings, a first horizontal direction, a second horizontal direction, and a vertical direction may be understood as follows: The first horizontal direction is a Y-axis direction, the second horizontal direction is an X-axis direction, and the vertical direction is a Z-axis direction.

The inkjet heads 210 may each supply any one of R color, G color, and B color chemicals when the target is a substrate S for a color filter. In this case, the chemicals may be inks of R color, G color, and B color. The inkjet heads 210 respectively supplying R color, G color, and B color chemicals may be positioned adjacent to each other.

The driver 204 coupled to the bracket 202 on which the inkjet heads 210 are installed may include first guide members 150 and 152 for moving the head assembly 200 in the first horizontal direction Y, a second guide member 206 for moving the head assembly 200 in a second horizontal direction X, and a driving member 205. The driver 204 may move the head assembly 200 in the first horizontal direction Y, the second horizontal direction X, and the vertical direction Z. In addition, the driver 204 may rotate the inkjet heads 210 around the respective central axes thereof.

The stage 112 provided as a stone surface plate may include a chucking zone 120 located in one upper part of the stage 112 for chucking the substrate S and a maintenance zone located in the other upper part of the stage 112 for cleaning the head assembly 200. The chucking zone 120 may include a chuck 124 that linearly moves toward the index 106 to receive the substrate S, chucks the substrate S when the substrate S is seated, and moves to the opposite side of the index 106, i.e., to a position where chemicals are applied to the substrate S, a chuck driver 126 that moves or rotates the chuck 124 in at least one linear direction, and a third guide member 122 for guiding the chuck 124 to linearly move. The chuck 124 coupled to the chuck driver 126 at a lower part thereof may linearly move in the Y-axis direction along the third guide member 122.

In addition, the first guide members 150 and 152 are installed on the stage 112 to correspond to both ends of the gantry 114. The first guide members 150 and 152 extend along the Y-axis direction and have the same width as the stage 112. The first guide members 150 and 152 are provided long on both upper ends of the stage 112 along the Y-axis direction to linearly move the gantry 114 in the Y-axis direction.

The gantry 114 may be coupled to the driver 204 at one part thereof and coupled to sliders 154 at both lower ends thereof. The driving member 205 may be provided inside the gantry 114. The driving member 205 may provide power to move the head assembly 200 in the first horizontal direction Y or the second horizontal direction X. That is, the driving member 205 may provide power to enable the bracket 202 coupled to the driver 204 to move linearly. The driving member 205 may include, for example, a motor, a gear, a pulley, a belt, a ball screw, or a linear motor, but is not limited thereto.

A pressure controller 118 may be installed on one upper part of the gantry 114 to control general operations of the chemical dispensing apparatus 110, e.g., pressure control, chemical supply and dispense, and the like. The gantry 114 may have the same width as the stage 112 in the X-axis direction. That is, the gantry 114 may be coupled to the sliders 154 at both lower ends thereof, and the sliders 154 may be provided to be movable in the Y-axis direction along the first guide members 150 and 152. The gantry 114 may also move the head assembly 200 in the X-axis direction by linearly moving the bracket 202 in the X-axis direction using the driver 204.

In addition, the pressure controller 118 includes a meniscus pressure control (MPC) unit for controlling the internal pressure of the inkjet heads 210. The pressure controller 118 controls the internal pressure of the inkjet heads 210 to a negative pressure and individually controls piezoelectric elements (not shown) to uniformly dispense chemicals from the respective nozzles when the chemicals are supplied.

The chemical dispensing apparatus 110 moves the head assembly 200 to a location 200a corresponding to the maintenance zone to clean the inkjet heads 210.

The maintenance zone may include a first cleaning unit 130 and a second cleaning unit 140. When the head assembly 200 is moved to the other side of the stage 112 in the X-axis direction by the driver 204, the inkjet heads 210 may be positioned above the maintenance zone. The chemicals remaining on the nozzle surface of the inkjet heads 210 are removed in a non-contact manner as the inkjet heads 210 linearly move above the maintenance zone while maintaining a certain distance therebetween.

The maintenance zone may include the first cleaning unit 130 for primarily cleaning the inkjet heads 210 and the second cleaning unit 140 for cleaning the nozzle surface of the inkjet heads 210.

The first cleaning unit 130 may include blades (132 in FIG. 3) for removing the chemicals remaining on the nozzle surface in a non-contact manner, and a purge tank 134 for collecting the chemicals removed by the blades 132.

In addition, when the chemicals remaining inside the inkjet heads 210 are dispensed by placing the inkjet heads 210 above the first cleaning unit 130 and increasing the internal pressure of the inkjet heads 210, the purge tank 134 may collect the dispensed chemicals. The blades 132 may be installed on top of the purge tank 134. The blades 132 may be provided as many as the number of inkjet heads 210. The blades 132 may remove the chemicals from the nozzle surface of the inkjet heads 210 in a non-contact manner.

The second cleaning unit 140 may use a roll-type wiper 142 to clean the nozzle surface from which the chemicals are removed in the first cleaning unit 130.

As such, chemicals remaining on a nozzle surface of heads may be removed therefrom in a non-contact manner.

FIG. 4 is a schematic perspective view of a chemical storage apparatus of the chemical dispensing apparatus of FIG. 3. FIG. 5 is a schematic perspective view of a receptacle and a sensor.

Referring to FIGS. 4 and 5, the chemical storage apparatus 201 may include the chemical tank 220, the first fixing member 230, the second fixing member 235, the sensor 240, the receptacle 245, and the coupling members 270. The chemical tanks 220 may be configured to store chemicals. According to embodiments, the chemical tank 220 may receive and temporarily store chemicals from the chemical supplier (105 in FIG. 1), and supply the stored chemicals to heads of the inkjet heads (210 in FIG. 2).

According to embodiments, the chemical tank 220 may include non-conductive material. As the chemical tank 220 includes non-conductive material, when the sensor 240 is a capacitance-type liquid level sensor, an error in liquid level measurement may be prevented. In embodiments, the chemical tank 220 may include at least one of polytetrafluoroethylene (PTFE) and perfluoro-alkoxy polymer (PFA), but is not limited thereto.

The chemical tank 220 may have a cuboid shape, a cylindrical shape, etc., but is not limited thereto. A first surface 221, which is a side of the chemical tank 220 contacting the receptacle 245, more specifically the first body 251 of the first plate 250, may have a curve with a diameter of 40 mm or more or may be flat. In embodiments, the first surface 221, which is a side wall of the chemical tank 220, may have a shape different from the other sidewalls of the chemical tank 220.

According to embodiments, the first surface 221 of the chemical tank 220 may have the same curve as the sensor 240. The first surface 221 of the chemical tank 220 may have the same curve as the first body 251 of the first plate 250.

The first fixing member 230 may be disposed on an upper surface of the chemical tank 220. According to embodiments, the first fixing member 230 may be coupled to the upper surface of the chemical tank 220.

The second fixing member 235 may be disposed on a lower surface of the chemical tank 220. According to embodiments, the second fixing member 235 may be coupled to the lower surface of the chemical tank 220. The first fixing member 230 and the second fixing member 235 may include non-conductive material. As the first fixing member 230 and the second fixing member 235 may include non-conductive material, when the sensor 240 is a capacitance-type liquid level sensor, an error in liquid level measurement may be prevented. In embodiments, the first fixing member 230 and the second fixing member 235 may include at least one of PTFE and PFA, but is not limited thereto.

Each of the first fixing member 230 and the second fixing member 235 may include a valve 280 for controlling the flow rate of the chemicals. According to embodiments, the first fixing member 230 may include a valve 280 for controlling the flow rate of the chemicals supplied to the chemical tank 220, and the second fixing member 235 may include a valve 280 for controlling the flow rate of the chemicals supplied from the chemical tank 220 to the heads of the inkjet heads (210 in FIG. 3).

The first fixing member 230 and the second fixing member 235 may include fasteners 231 fastened to the coupling members 270, respectively. The fasteners 231 may be configured to be attached to or detached from the coupling members 270.

The sensor 240 may be configured to measure a specific parameter of the chemicals stored in the chemical tank 220. According to embodiments, the parameter may include, but is not limited to, the liquid level, pressure, and temperature of the chemicals.

According to embodiments, the sensor 240 may be a liquid level sensor that measures the pressure of the chemicals stored in the chemical tank 220. According to embodiments, the sensor 240 may be a liquid level sensor that continuously measures the liquid level of the chemicals stored in the chemical tank 220. When the liquid level of chemicals is continuously measured, it may be understood that the liquid level of chemicals is quantitatively measured. This may indicate that the liquid level of the chemicals is quantitatively measured, rather than merely measuring whether the chemicals are above or below a certain level. According to embodiments, the sensor 240 may be a capacitance-type sensor, but is not limited thereto. The sensor 240 may have the same curve as the first surface 221 of the chemical tank 220.

According to embodiments, the sensor 240 may further include a sensor head 241 having a hook shape. As shown in FIG. 5, the sensor head 241 may fix the sensor 240 to the second plate 260 in the form of a hook. That is, the sensor 240 may be fixed to the second plate 260 as the sensor head 241 is coupled to the second plate 260 in the form of a hook.

The receptacle 245 may be configured to accommodate the sensor 240. That is, the sensor 240 may be accommodated in the receptacle 245. The receptacle 245 may include the first plate 250 and the second plate 260. The first plate 250 may include the first body 251 and the first heads 253. The receptacle 245 may include non-conductive material. In embodiments, the first plate 250 and the second plate 260 of the receptacle 245 may include non-conductive material. As the receptacle 245 includes non-conductive material, when the sensor 240 is a capacitance-type liquid level sensor, an error in liquid level measurement may be prevented. In embodiments, the receptacle 245 may include at least one of PTFE and PFA, but is not limited thereto.

The first body 251 may include a recess R in which a space to accommodate the sensor 240 is formed. The first body 251 is configured such that a surface opposite to the surface on which the recess R is formed is in contact with the first surface 221 of the chemical tank 220. The first heads 253 may have a shape protruding from the first body 251 in the vertical direction Z. According to embodiments, the number of the first heads 253 may be two since the first heads 253 are formed at both ends of the first body 251, respectively, in the vertical direction.

The first body 251 may have the same curve as the sensor 240. Thus, the sensor 240, the first body 251, and the first surface 221 of the chemical tank 220 may have a curve with a diameter of 40 mm or more or may be flat. Accordingly, the sensor 240, the first body 251, and the first surface 221 may be in contact with each other without forming a gap, and the liquid level of the chemicals stored in the chemical tank 220 may be accurately measured when the sensor 240 is a capacitance-type liquid level sensor but is not limited thereto.

According to embodiments, the sum of the thickness of the first body 251 and the thickness of the first surface 221 along the second horizontal direction Y may be 6 mm or less. Accordingly, when the sensor 240 is a capacitance-type liquid level sensor, the liquid level of the chemicals stored in the chemical tank 220 may be accurately measured.

The first heads 253 may include holes H extending in the second horizontal direction Y. A diameter of the holes H may be substantially the same as a diameter of the coupling members 270.

The second plate 260 may be configured to cover the sensor 240 accommodated in the first plate 250. According to embodiments, the second plate 260 may have a plate shape extending in the vertical direction Z, but is not limited thereto. According to embodiments, the second plate 260 may have the same curve as the sensor 240. Accordingly, the sensor 240 can be accommodated in the receptacle 245 without forming a gap. The second plate 260 may be coupled to the first plate 250. According to embodiments, the second plate 260 may be coupled to the first plate 250 by bolts, but is not limited thereto.

As the sensor 240 is accommodated in the receptacle 245, the sensor 240 may be protected from external impact. In addition, inflow of foreign substances into the sensor 240 may also be prevented.

According to embodiments, a process of removing air layers through a packing operation may be performed while the sensor 240 is accommodated in the receptacle 245. Accordingly, the sensor 240 may accurately measure a specific parameter of chemicals in the chemical tank 220.

The coupling members 270 may be configured to attach or detach the receptacle 245 to or from the first fixing member 230 and the second fixing member 235, respectively, in a one-touch manner. According to embodiments, the coupling members 270 may be configured to attach or detach the first plate 250 to or from the first fixing member 230 and the second fixing member 235, respectively, in a one-touch manner. According to embodiments, the coupling members 270 may be inserted into the holes H formed in the first heads 253 of the first plate 250 and may be fastened to the fasteners 231 formed on the first fixing member 230 and the second fixing member 235, respectively. Accordingly, the first plate 250 may contact the first surface 221 of the chemical tank 220 when the coupling members 270 are fastened to the fasteners 231.

The coupling members 270 may include a knob. The first plate 250 may be attached to or detached from the first fixing member 230 and the second fixing member 235 by rotation of the knob.

The coupling members 270 may attach or detach the receptacle 245 to or from the fixing members 230 and 235 in a one-touch manner, but are not limited to the knob.

The chemical storage apparatus 201 may measure a specific parameter of the chemicals stored in the chemical tank 220 when the sensor 240 is accommodated in the receptacle 245. That is, it is easy to replace the sensor 240 because the sensor 240 may function normally without being directly attached to the chemical tank 220. In addition, since the receptacle 245 in which the sensor 240 is accommodated is detachable from the first fixing member 230 and the second fixing member 235 in a one-touch manner, it is easy to remove and replace the sensor 240 by detaching the receptacle 245 without a separate tool even when an error occurs in the sensor 240.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A chemical storage apparatus comprising:
a reservoir including a chemical tank configured to store a chemical, a first fixing member located on an upper surface of the chemical tank, and a second fixing member located on a lower surface of the chemical tank;
a sensor configured to measure a specific parameter of the chemical stored in the reservoir;
a receptacle having a space in which the sensor is accommodated;
coupling members for attaching or detaching the receptacle to or from the first fixing member and the second fixing member, respectively, in a one-touch manner.

2. The chemical storage apparatus of claim 1,
wherein the receptacle includes a first plate and a second plate,
wherein the first plate has a recess in which the sensor is accommodated, and contacts a first surface which is a side of the chemical tank, and
the second plate covers the sensor accommodated in the recess.

3. The chemical storage apparatus of claim 2,
wherein the first surface has a curvature with a diameter of about 40 mm or more or is flat.

4. The chemical storage apparatus of claim 2,
wherein the first plate includes a first body with a recess, and first heads protruding in a vertical direction from the first body and having holes formed therein,
and the coupling members pass through the holes and are coupled to the first fixing member and the second fixing member, respectively.

5. The chemical storage apparatus of claim 4,
wherein the coupling members include a knob.

6. The chemical storage apparatus of claim 4,
wherein a sum of a thickness of the first body and a thickness of the first surface in a second horizontal direction is about 6 mm or less.

7. The chemical storage apparatus of claim 1,
wherein the sensor comprises a liquid level sensor configured to continuously measure a liquid level of the chemical stored in the reservoir.

8. The chemical storage apparatus of claim 7,
wherein the liquid level sensor comprises a capacitance-type liquid level sensor.

9. The chemical storage apparatus of claim 1,
wherein each of the first fixing member and the second fixing member has a valve configured to control a flow rate of the chemical.

10. The chemical storage apparatus of claim 2,
wherein the chemical tank, the first plate, the second plate, the first fixing member, the second fixing member, and the receptacle each include a non-conductive material.

11. A chemical dispensing apparatus comprising:
a chuck configured to support a substrate;
a head having a nozzle configured to dispense a chemical toward the substrate;
a body to which the head is coupled;
a bracket coupled to the body;
a reservoir including a chemical tank positioned in the body and configured to store a chemical, a first fixing member disposed on an upper surface of the chemical tank, a second fixing member disposed on a lower surface of the chemical tank, and a supply line for supplying the chemical to the nozzle;
a sensor contacting the reservoir and configured to measure a specific parameter of the chemical stored in the reservoir;
a receptacle having a space in which the sensor is accommodated; and
coupling members for attaching or detaching the receptacle to or from the first fixing member and the second fixing member, respectively, in a one-touch manner.

12. The chemical dispensing apparatus of claim 11,
wherein the receptacle includes a first plate and a second plate,
wherein the first plate has a recess in which the sensor is accommodated, and contacts a first surface which is a side of the chemical tank, and
the second plate covers the sensor accommodated in the recess.

13. The chemical dispensing apparatus of claim 12,
wherein the first surface has a curvature with a diameter of about 40 mm or more or is flat.

14. The chemical dispensing apparatus of claim 12,
wherein the first plate includes a first body with a recess, and first heads protruding in a vertical direction from the first body and having holes formed therein,
and the coupling members pass through the holes and are coupled to the first fixing member and the second fixing member, respectively.

15. The chemical dispensing apparatus of claim 14,
wherein a sum of a thickness of the first body and a thickness of the first surface in a second horizontal direction is about 6 mm or less.

16. The chemical dispensing apparatus of claim 11,
wherein the sensor comprises a capacitance-type liquid level sensor configured to continuously measure a liquid level of the chemical stored in the reservoir.

17. The chemical dispensing apparatus of claim 11,
wherein the chemical tank, the first fixing member, the second fixing member, and the receptacle each included a non-conductive material.

18. A chemical dispensing apparatus comprising:
a chuck configured to support a substrate;
a head having a nozzle configured to dispense a chemical toward the substrate;
a body to which the head is coupled;
a bracket coupled to the body;
a reservoir including a chemical tank disposed in the body and configured to store a chemical, a first fixing member disposed on an upper surface of the chemical tank, a second fixing member disposed on a lower surface of the chemical tank, and a supply line for supplying the chemical to the nozzle;
a liquid level sensor contacting the reservoir and configured to measure a liquid level of the chemical stored in the reservoir;
a receptacle including a first plate having a recess in which the liquid level sensor is accommodated and a second plate that covers the liquid level sensor accommodated in the recess; and
coupling members for attaching or detaching the receptacle to or from the first fixing member and the second fixing member, respectively, in a one-touch manner;
wherein a first surface which is a side of the chemical tank has a curvature with a diameter of about 40 mm or more or is flat,
wherein the first plate includes a first body in which the recess is formed, and first heads protruding from the first body in a vertical direction and having holes therein,
and wherein a sum of a thickness of the first body and a thickness of the first surface in a second horizontal direction is about 6 mm or less.

19. The chemical dispensing apparatus of claim 18,
wherein each of the first fixing member and the second fixing member includes a valve configured to control a flow rate of the chemical.

20. The chemical dispensing apparatus of claim 18,
wherein the liquid level sensor comprises a capacitance-type liquid level sensor configured to continuously measure the liquid level of the chemical stored in the reservoir.
